(19) United States
(12) Patent Application Publication
(10) Pub. No.: US 2026/0102304 A1
(43) Pub. Date: Apr. 16, 2026

(54) CARDIAC REHABILITATION ASSISTIVE THERAPY DEVICE

(71) Applicant: The Third Affiliated Hospital, Guangzhou Medical University (GZ Critical Pregnant Women Center), Guangzhou (CN)

(72) Inventors: Shixiang WANG, Guangzhou (CN); Youquan CHEN, Guangzhou (CN)

(21) Appl. No.: 19/295,695

(22) Filed: Aug. 11, 2025

Related U.S. Application Data
(63) Continuation of application No. PCT/CN2024/125136, filed on Oct. 16, 2024.

(51) Int. Cl. A61H 1/02

(52) U.S. Cl. CPC A61H 1/024; A61H 2001/0203; A61H 2201/0192; A61H 2201/1215; A61H 2201/1246; A61H 2201/1261; A61H 2201/14; A61H 2201/1623; A61H 2201/1633; A61H 2201/1635; A61H 2201/164; A61H 2201/1654; A61H 2201/1669; A61H 2201/1671; A61H 2201/5056; A61H 2203/0425; A61H 2205/08; A61H 2230/065

(57) ABSTRACT

The present disclosure relates to the technical field of assistive rehabilitation equipment, specifically to a cardiac rehabilitation assistive therapy device. The device comprises an exercise assistance mechanism configured to assist a patient in performing reciprocal waist twisting exercises, wherein the exercise assistance mechanism comprises a turntable. In the present disclosure, when pressure applied by the pressure springs to a bottom one of the second piston disks decreases, resistance encountered by the patient during waist twisting reduces accordingly. As the square tube communicates with the four-way shell through a hose, when hydraulic pressure in the four-way shell decreases, a height of the rubber plate also decreases. Consequently, abutment force between the friction plate and the rubber plate diminishes, thereby reducing resistance encountered by the patient during knee flexion exercises. Thus, upon detecting increased heart rate of the patient via the heart rate belt, the device will reduce movement resistance correspondingly.

### CROSS-REFERENCE TO RELATED APPLICATIONS

This application is a continuation of International Application No. PCT/CN2024/125136, filed on Oct. 16, 2024. All of the aforementioned applications are incorporated herein by reference in their entireties.

### TECHNICAL FIELD

The present disclosure relates to the technical field of assistive rehabilitation equipment, specifically to a cardiac rehabilitation assistive therapy device.

### BACKGROUND

Cardiac assisted rehabilitation therapy constitutes a comprehensive treatment process aimed at improving cardiac function in patients with heart disease, enhancing quality of life, and reducing occurrence of complications. During rehabilitation, cardiac patients should not remain bedridden indefinitely. Beyond scientifically standardized pharmacological treatment, rehabilitation necessitates emphasis on psychological recovery, dietary management, correction of detrimental habits, and most critically, exercise rehabilitation. Appropriate and regular exercise improves cardiac function in patients, enhances quality of life, prolongs prognosis, and reduces mortality rates from cardiovascular diseases. Rehabilitation training and clinical drug therapy represent two complementary and indispensable treatment components. Appropriate pharmacological treatment relatively enhances exercise capacity in patients and elevates training levels and efficacy, while beneficial effects of exercise training facilitate gradual reduction of medication dosage.

Cardiac rehabilitation patients must avoid excessive exercise during physical activity to prevent increased cardiac burden. When exercise intensity exceeds myocardial oxygen consumption capacity, myocardial hypoxia occurs. Additionally, excessively elevated heart rates in patients impair cardiac diastolic function, thereby compromising cardiac pumping capacity. This reduces cardiac output and fails to meet demands of bodily systems. Consequently, cardiac rehabilitation patients require adjustment of equipment resistance and intensity based on heart rate during exercise. Existing rehabilitation assistive devices exhibit overly complex adjustment methods for exercise apparatus resistance and lack automated regulation according to the heart rate of rehabilitation patients.

### SUMMARY

The object of the present disclosure is to provide a cardiac rehabilitation assistive therapy device to solve the problems raised in the above background.

To achieve this objective, the present disclosure provides the following technical solutions:

A cardiac rehabilitation assistive therapy device, comprising:
an exercise assistance mechanism, configured to assist a patient in performing reciprocal waist twisting exercises, wherein the exercise assistance mechanism comprises a turntable;
a knee flexion mechanism, configured to assist the patient in performing leg knee flexion exercises, wherein the knee flexion mechanism is fixedly arranged at a bottom of the turntable; and
an adjustment mechanism, configured to automatically adjust exercise resistance based on the patient's heart rate, wherein the adjustment mechanism comprises a liquid storage tank, a control box is fixedly connected to a top of the liquid storage tank, a microcontroller is fixedly connected inside the control box, a drive motor is fixedly connected to a top of the control box, a motor drive device is fixedly connected to the drive motor, a circular shell is fixedly connected to a bottom of the drive motor, an impeller is fixedly connected to an output end of the drive motor, and a four-way shell is fixedly connected to one side of the circular shell.

Further, the exercise assistance mechanism comprises:
a backrest plate, fixedly connected to a top of the turntable;
a seat cushion, fixedly provided on the turntable;
a rotating column, fixedly connected to a center position of the bottom of the turntable;
a support frame, rotatably sleeved over an outer portion of the rotating column;
two L-shaped plates, symmetrically and fixedly connected to a top of the support frame;
a U-shaped rod, wherein one end of the U-shaped rod is rotatably connected to one of the L-shaped plates;
two grip handles, symmetrically and fixedly connected to a side wall of the U-shaped rod; and
a heart rate belt, fixedly connected to the side wall of the U-shaped rod.

Further, a clamping block is slidably embedded in one of the L-shaped plates, a pull rod is fixedly connected to an end portion of the clamping block, a return spring is sleeved over an outer portion of the pull rod, and an end portion of the return spring is fixedly connected to an inner wall of one of the L-shaped plates.

Further, the exercise assistance mechanism comprises:
two arc-shaped rods, symmetrically and fixedly connected to an outer wall of the rotating column;
two piston blocks, each fixedly connected to an end portion of one of the arc-shaped rods;
two arc-shaped sleeves, each slidably sleeved over an outer portion of one of the arc-shaped rods;
two connecting tubes, each fixedly connected at one end to an end portion of one of the arc-shaped sleeves, wherein each of the arc-shaped sleeves is in communication with an inner portion of each of the connecting tubes; and
two positioning arms, each fixedly sleeved over an outer portion of one of the arc-shaped sleeves.

Further, the knee flexion mechanism comprises:
a support plate, configured to support a leg of the patient;
two limiting grooves, symmetrically formed in the support plate;
a positioning base, fixedly connected to the bottom of the turntable, wherein an end portion of the support plate is fixedly connected to the positioning base;
two pedal plates, slidably embedded in and connected to each of the limiting grooves;
two limiting blocks, each fixedly connected to a side wall of each of the pedal plates, wherein each of the limiting blocks is slidably embedded in and connected to each of the limiting grooves;
two ankle straps, wherein an end portion of each of the ankle straps is fixedly connected to the side wall of each of the pedal plates;
two sliding plates, each slidably sleeved over a bottom end of each of the pedal plates; and
two compression springs, each fixedly connected to a top of each of the sliding plates.

Further, the knee flexion mechanism comprises:
a friction plate, fixedly connected between bottom ends of the two sliding plates;
a rubber plate, slidably abutting against a bottom of the friction plate; and
a telescopic plate, fixedly connected to a center position of a bottom of the rubber plate.

Further, the knee flexion mechanism comprises:
a square tube, slidably sleeved over the telescopic plate;
a hose, wherein one end of the hose is fixedly connected to a bottom of the square tube, and the square tube is in communication with an inner portion of the hose; and
two limiting rods, symmetrically and fixedly connected to a bottom of the support plate, wherein the rubber plate is slidably sleeved over the limiting rods.

Further, the adjustment mechanism comprises:
a straight tube, fixedly connected to a bottom of the circular shell;
an auger, fixedly connected to a center of the impeller and rotatably sleeved inside the straight tube; and
a throttle valve, fixedly connected to an end portion of the four-way shell.

Further, the adjustment mechanism comprises:
a sealing cylinder, fixedly connected to a top of the four-way shell and in communication with an inner portion of the four-way shell;
a hydraulic rod, slidably sleeved inside the sealing cylinder;
an extrusion spring, fixedly sleeved over an outer portion of the hydraulic rod;
a first piston disk, fixedly connected to a top end of the hydraulic rod;
a pneumatic cylinder, slidably sleeved over the first piston disk; and
a branch tube, fixedly connected to a center position of a top end of the pneumatic cylinder.

Further, the adjustment mechanism comprises:
two adjustment cylinders, symmetrically and fixedly connected to an end portion of the branch tube;
a one-way valve, fixedly provided on an outer wall of each of the adjustment cylinders;
two second piston disks, each slidably sleeved inside each of the adjustment cylinders, and a circular ring for limiting a position of one of the second piston disks at a bottom end is fixedly connected to an inner wall of each of the adjustment cylinders;
three pressure springs, fixedly connected between the two second piston disks; and
an airbag, provided at a top end of each of the adjustment cylinders and abutting against a top of one of the second piston disks.

Compared with prior art, the beneficial effects of the present disclosure are:
1. The patient is capable of twisting the body left and right to drive the turntable to rotate. Rotation of the turntable enables the arc-shaped rods to drive the piston blocks to slide within the arc-shaped sleeves, thereby compressing air through the connecting tubes into the adjustment cylinders. Under air pressure, the second piston disks are pressed to rise, causing the pressure springs to contract. The pressure springs generate a counteracting force against the second piston disks. Consequently, the patient encounters controlled resistance during twisting motions. This resistance is automatically adjustable based on the patient's heart rate, ensuring appropriate exercise intensity. Thus, the patient is capable of exercising waist muscles to promote lumbar blood circulation. The patient's feet are capable of being fixed to two pedal plates for knee flexion exercises. When the feet drive the pedal plates, the limiting blocks at ends of the pedal plates slide along the limiting grooves, enabling the pedal plates to drive the sliding plates and a bottom friction plate to move. The compression springs press the sliding plates and the friction plate downward against a rubber plate, thereby creating resistance that the patient experiences during knee flexion. This resistance contributes to strengthening thigh and calf muscles of the patient while promoting leg blood circulation. The patient is capable of improving cardiac function and assisting cardiac rehabilitation through appropriate waist and leg exercises. Combined waist-leg training enables patients confined to bed for extended periods to perform cardiac rehabilitation exercises, rather than exercising through walking or sprinting, thereby preventing excessive burden on the heart of the patient.
2. The heart rate belt is capable of detecting the heart rate of the patient during exercise. Then, the detected heart rate data is transmitted to a microcontroller for signal processing and heart rate calculation. The microcontroller converts the heart rate data into PWM (Pulse Width Modulation) signals and then transmits the PWM signals to a motor driver. The motor driver controls rotational speed of the motor based on the PWM signals, wherein heart rate values are mapped to the PWM signals such that higher heart rates reduce the PWM duty cycles, thereby decreasing the motor rotational speed. Consequently, in the device, an output end of the drive motor drives an impeller at a reduced rotational speed, so that less water is pumped from a liquid storage tank into the four-way shell. As the ends of the four-way shell sustain flow via a throttle valve, hydraulic pressure within the four-way shell decreases. Then, reduced hydraulic pressure on a hydraulic rod allows the hydraulic rod to descend under extrusion force from an extrusion spring. Thus, descending motion of a first piston disk extracts air from two airbags, therefore the airbags gradually contract. Consequently, positions of a top one of the second piston disks rise. This reduces pressure applied by the pressure springs to a bottom one of the second piston disks, thereby reducing resistance encountered by the patient during waist twisting. As the square tube communicates with the four-way shell through a hose, when hydraulic pressure in the four-way shell decreases, a height of the rubber plate also decreases. Consequently, abutment force between the friction plate and the rubber plate diminishes, even causing separation between the rubber plate and the friction plate. This reduces resistance encountered by the patient during knee flexion exercises. Thus, upon detecting increased heart rate of the patient via the heart rate belt, the device will reduce movement resistance correspondingly. Conversely, when the heart rate of the patient gradually returns to a normal state, the adjustment mechanism will progressively increase movement resistance. This configuration is capable of preventing excessive exercise intensity in cardiac patients while facilitating cardiac rehabilitation therapy.

### BRIEF DESCRIPTION OF THE DRAWINGS

FIG. 1 is a schematic diagram of the overall structure of the present disclosure;

FIG. 2 is a top-view structural schematic diagram of the overall structure of the present disclosure;

FIG. 3 is a structural schematic diagram of an exercise assistance mechanism of the present disclosure;

FIG. 4 is a structural schematic diagram of an arc-shaped sleeve of the present disclosure;

FIG. 5 is a schematic diagram of an L-shaped plate connecting structure of the present disclosure;

FIG. 6 is a structural schematic diagram of a knee flexion mechanism of the present disclosure;

FIG. 7 is a schematic diagram of a support plate connecting structure of the present disclosure;

FIG. 8 is a structural schematic diagram of a pedal plate of the present disclosure;

FIG. 9 is a structural schematic diagram of an adjustment mechanism of the present disclosure;

FIG. 10 is a schematic diagram of an internal structure of a pneumatic cylinder of the present disclosure;

FIG. 11 is a schematic diagram of an internal structure of an adjustment cylinder of the present disclosure;

FIG. 12 is a schematic cross-sectional diagram of an internal structure of a liquid storage tank of the present disclosure.

Reference numerals in the drawings: 100. Exercise assistance mechanism; 101. Turntable; 102. Backrest plate; 103. Seat cushion; 104. Rotating column; 105. Support frame; 106. L-shaped plate; 107. U-shaped rod; 108. Grip handle; 109. Heart rate belt; 110. Clamping block; 111. Return spring; 112. Pull rod; 113. Arc-shaped rod; 114. Piston block; 115. Arc-shaped sleeve; 116. Connecting tube; 117. Positioning arm; 200. Knee flexion mechanism; 201. Support plate; 202. Limiting groove; 203. Positioning base; 204. Pedal plate; 205. Limiting block; 206. Ankle strap; 207. Sliding plate; 208. Compression spring; 209. Friction plate; 210. Rubber plate; 211. Telescopic plate; 212. Square tube; 213. Hose; 214. Limiting rod; 300. Adjustment mechanism; 301. Liquid storage tank; 302. Drive motor; 303. Control box; 304. Circular shell; 305. Impeller; 306. Straight tube; 307. Auger; 308. Four-way shell; 309. Throttle valve; 310. Sealing cylinder; 311. Hydraulic rod; 312. Extrusion spring; 313. First piston disk; 314. Pneumatic cylinder; 315. Branch tube; 316. Adjustment cylinder; 317. One-way valve; 318. Second piston disk; 319. Pressure spring; 320. Airbag.

### DETAILED DESCRIPTION OF THE EMBODIMENTS

The technical solutions in the embodiments of the present disclosure will be described clearly and completely below in conjunction with the accompanying drawings in the embodiments of the present disclosure. Evidently, the described embodiments represent merely part of the embodiments of the present disclosure, not all embodiments. All other embodiments obtained by persons of ordinary skill in the art based on the embodiments of the present disclosure without creative effort shall fall within the scope of protection of the present disclosure.

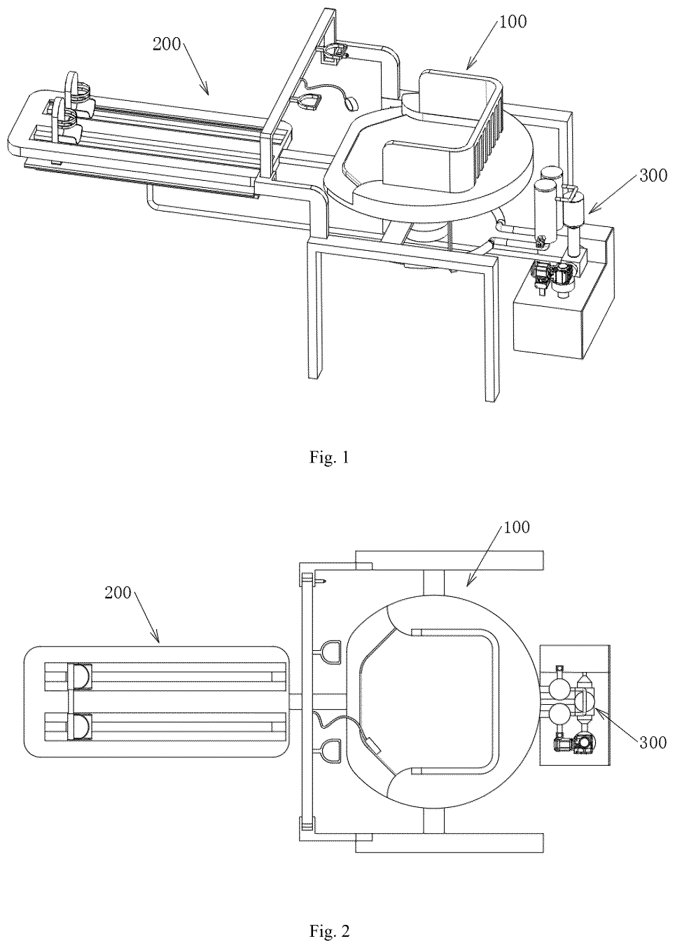

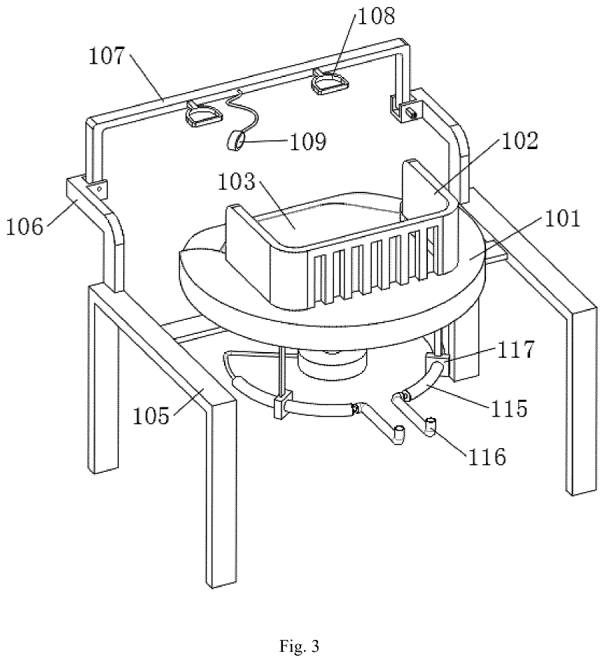

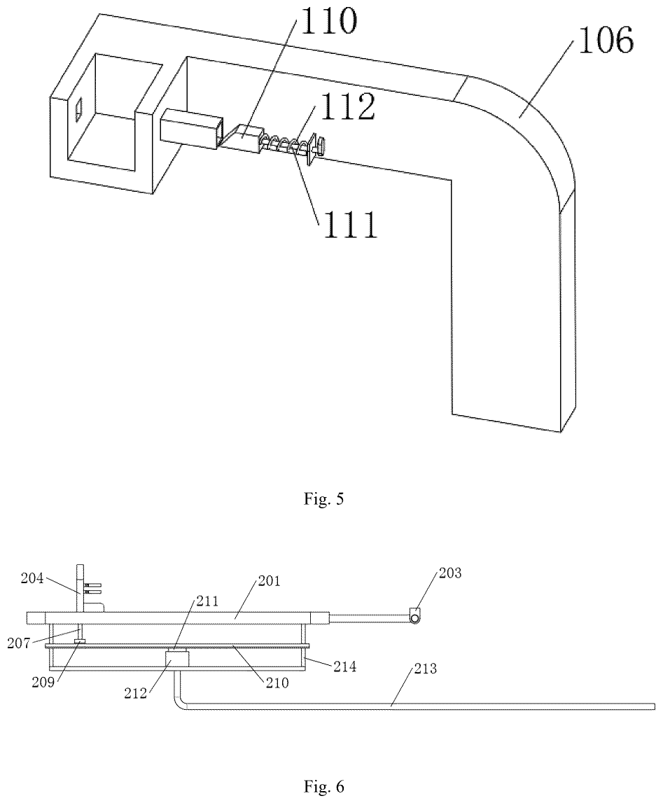

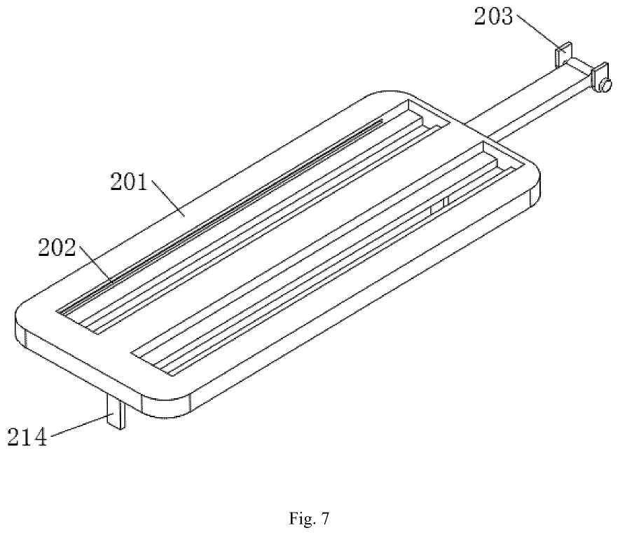

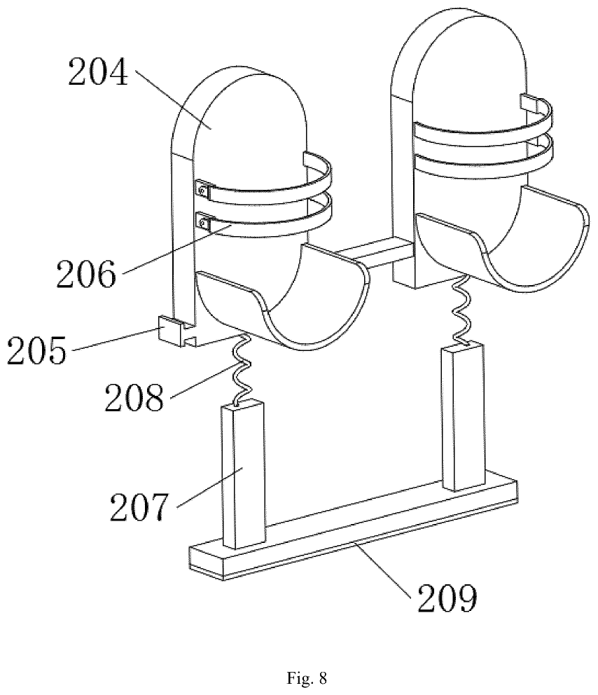

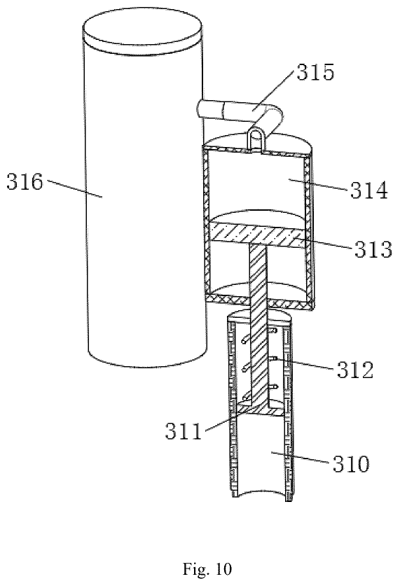

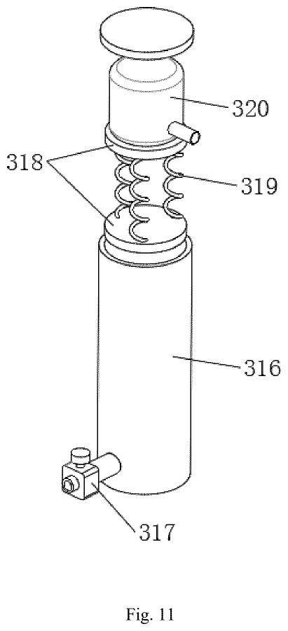

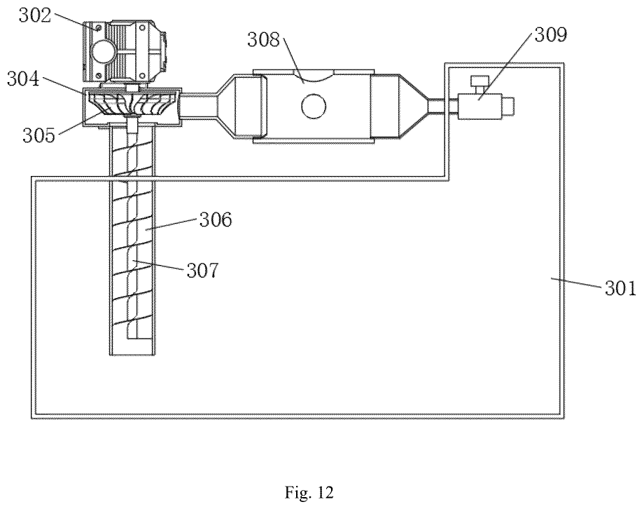

Referring to FIGS. 1-12, in an embodiment of the present disclosure, a cardiac rehabilitation assistive therapy device, comprising: an exercise assistance mechanism 100 configured to assist a patient in performing reciprocal waist twisting exercises, wherein the exercise assistance mechanism 100 comprises a turntable 101; a knee flexion mechanism 200 configured to assist the patient in performing leg knee flexion exercises, wherein the knee flexion mechanism 200 is fixedly arranged at a bottom of the turntable 101; and an adjustment mechanism 300 configured to automatically adjust exercise resistance based on the patient's heart rate, wherein the adjustment mechanism 300 comprises a liquid storage tank 301, a control box 303 is fixedly connected to a top of the liquid storage tank 301, a microcontroller is fixedly connected inside the control box 303, a drive motor 302 is fixedly connected to a top of the control box 303, a motor drive device is fixedly connected to the drive motor 302, a circular shell 304 is fixedly connected to a bottom of the drive motor 302, an impeller 305 is fixedly connected to an output end of the drive motor 302, and a four-way shell 308 is fixedly connected to one side of the circular shell 304.

Specifically, the patient may sit on the turntable 101 and rotate the U-shaped rod 107. An end portion of the U-shaped rod 107 abuts against the clamping block 110. Then, the return spring 111 presses the clamping block 110 to snap into the inner portion of the U-shaped rod 107 to lock the U-shaped rod 107. The patient wears the heart rate belt 109 at the wrist to detect heart rate of the patient. The patient is capable of twisting the body left and right to drive the turntable 101 to rotate. Rotation of the turntable 101 enables the arc-shaped rods 113 to drive the piston blocks 114 to slide within the arc-shaped sleeves 115, thereby compressing air through the connecting tubes 116 into the adjustment cylinders 316. Under air pressure, the second piston disks 318 are pressed to rise, causing the pressure springs 319 to contract. The pressure springs 319 generate a counteracting force against the second piston disks 318. Consequently, the patient encounters controlled resistance during twisting motions. This resistance is automatically adjustable based on the patient's heart rate, ensuring appropriate exercise intensity. Thus, the patient is capable of exercising waist muscles to promote lumbar blood circulation. The patient's feet are capable of being fixed to two pedal plates 204 for knee flexion exercises. When the feet drive the pedal plates 204, the limiting blocks 205 at ends of the pedal plates 204 slide along the limiting grooves 202, enabling the pedal plates 204 to drive the sliding plates 207 and a bottom friction plate 209 to move. The compression springs 208 press the sliding plates 207 and the friction plate 209 downward against a rubber plate 210, thereby creating resistance that the patient experiences during knee flexion. This resistance contributes to strengthening thigh and calf muscles of the patient while promoting leg blood circulation. The patient is capable of improving cardiac function and assisting cardiac rehabilitation through appropriate waist and leg exercises. Combined waist-leg training enables patients confined to bed for extended periods to perform cardiac rehabilitation exercises, rather than exercising through walking or sprinting, thereby preventing excessive burden on the heart of the patient.

The heart rate belt 109 is capable of detecting the heart rate of the patient during exercise. Then, the detected heart rate data is transmitted to a microcontroller for signal processing and heart rate calculation. The microcontroller converts the heart rate data into PWM (Pulse Width Modulation) signals and then transmits the PWM signals to a motor driver. The motor driver controls rotational speed of the motor based on the PWM signals, wherein heart rate values are mapped to the PWM signals such that higher heart rates reduce the PWM duty cycles, thereby decreasing the motor rotational speed. Consequently, in the device, an output end of the drive motor 302 drives an impeller 305 at a reduced rotational speed, so that less water is pumped from a liquid storage tank 301 into the four-way shell 308. As the ends of the four-way shell 308 sustain flow via a throttle valve 309, hydraulic pressure within the four-way shell 308 decreases. Then, reduced hydraulic pressure on a hydraulic rod 311 allows the hydraulic rod 311 to descend under extrusion force from an extrusion spring 312. Thus, descending motion of a first piston disk 313 extracts air from two airbags 320, therefore the airbags 320 gradually contract. Consequently, positions of a top one of the second piston disks 318 rise. This reduces pressure applied by the pressure springs 319 to a bottom one of the second piston disks 318, thereby reducing resistance encountered by the patient during waist twisting. As the square tube 212 communicates with the four-way shell 308 through a hose 213, when hydraulic pressure in the four-way shell 308 decreases, a height of the rubber plate 210 also decreases. Consequently, abutment force between the friction plate 209 and the rubber plate 210 diminishes, even causing separation between the rubber plate 210 and the friction plate 209. This reduces resistance encountered by the patient during knee flexion exercises. Thus, upon detecting increased heart rate of the patient via the heart rate belt 109, the device will reduce movement resistance correspondingly. Conversely, when the heart rate of the patient gradually returns to a normal state, the adjustment mechanism 300 will progressively increase movement resistance. This configuration is capable of preventing excessive exercise intensity in cardiac patients while facilitating cardiac rehabilitation therapy.

### EMBODIMENT 1

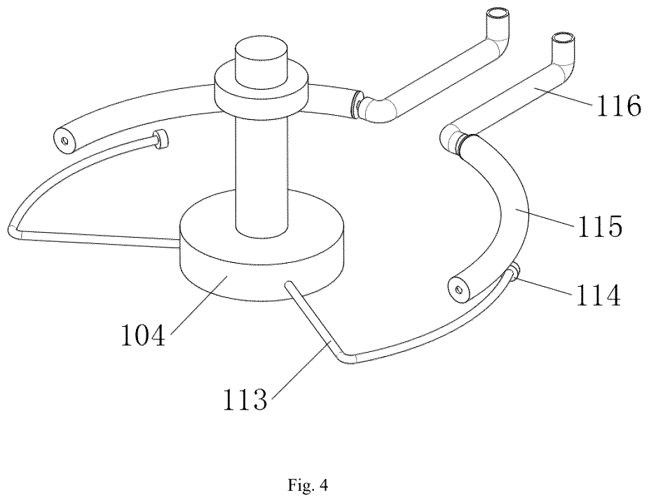

As shown in FIGS. 3-8, in this embodiment, the exercise assistance mechanism 100 comprises: a backrest plate 102, fixedly connected to a top of the turntable 101; a seat cushion 103, fixedly provided on the turntable 101; a rotating column 104, fixedly connected to a center position of the bottom of the turntable 101; a support frame 105, rotatably sleeved over an outer portion of the rotating column 104; two L-shaped plates 106, symmetrically and fixedly connected to a top of the support frame 105; a U-shaped rod 107, wherein one end of the U-shaped rod 107 is rotatably connected to one of the L-shaped plates 106; two grip handles 108, symmetrically and fixedly connected to a side wall of the U-shaped rod 107; and a heart rate belt 109, fixedly connected to the side wall of the U-shaped rod 107. A clamping block 110 is slidably embedded in one of the L-shaped plates 106, a pull rod 112 is fixedly connected to an end portion of the clamping block 110, a return spring 111 is sleeved over an outer portion of the pull rod 112, and an end portion of the return spring 111 is fixedly connected to an inner wall of one of the L-shaped plates 106. Two arc-shaped rods 113, symmetrically and fixedly connected to an outer wall of the rotating column 104; two piston blocks 114, each fixedly connected to an end portion of one of the arc-shaped rods 113; two arc-shaped sleeves 115, each slidably sleeved over an outer portion of one of the arc-shaped rods 113; two connecting tubes 116, each fixedly connected at one end to an end portion of one of the arc-shaped sleeves 115, wherein each of the arc-shaped sleeves 115 is in communication with an inner portion of each of the connecting tubes 116; and two positioning arms 117, each fixedly sleeved over an outer portion of one of the arc-shaped sleeves 115.

The knee flexion mechanism 200 comprises: a support plate 201, configured to support a leg of the patient; two limiting grooves 202, symmetrically formed in the support plate 201; a positioning base 203, fixedly connected to the bottom of the turntable 101, wherein an end portion of the support plate 201 is fixedly connected to the positioning base 203; two pedal plates 204, slidably embedded in and connected to each of the limiting grooves 202; two limiting blocks 205, each fixedly connected to a side wall of each of the pedal plates 204, wherein each of the limiting blocks 205 is slidably embedded in and connected to each of the limiting grooves 202; two ankle straps 206, wherein an end portion of each of the ankle straps 206 is fixedly connected to the side wall of each of the pedal plates 204; two sliding plates 207, each slidably sleeved over a bottom end of each of the pedal plates 204; and two compression springs 208, each fixedly connected to a top of each of the sliding plates 207. The knee flexion mechanism 200 comprises: a friction plate 209, fixedly connected between bottom ends of the two sliding plates 207; a rubber plate 210, slidably abutting against a bottom of the friction plate 209; and a telescopic plate 211, fixedly connected to a center position of a bottom of the rubber plate 210. A square tube 212, slidably sleeved over the telescopic plate 211; a hose 213, wherein one end of the hose 213 is fixedly connected to a bottom of the square tube 212, and the square tube 212 is in communication with an inner portion of the hose 213; and two limiting rods 214, symmetrically and fixedly connected to a bottom of the support plate 201, wherein the rubber plate 210 is slidably sleeved over the limiting rods 214.

During the specific implementation, the patient may sit on the turntable 101 and rotate the U-shaped rod 107. An end portion of the U-shaped rod 107 abuts against the clamping block 110. Then, the return spring 111 presses the clamping block 110 to snap into the inner portion of the U-shaped rod 107 to lock the U-shaped rod 107. The patient wears the heart rate belt 109 at the wrist to detect heart rate of the patient. The patient is capable of twisting the body left and right to drive the turntable 101 to rotate. Rotation of the turntable 101 enables the arc-shaped rods 113 to drive the piston blocks 114 to slide within the arc-shaped sleeves 115, thereby compressing air through the connecting tubes 116 into the adjustment cylinders 316. Under air pressure, the second piston disks 318 are pressed to rise, causing the pressure springs 319 to contract. The pressure springs 319 generate a counteracting force against the second piston disks 318. Consequently, the patient encounters controlled resistance during twisting motions. This resistance is automatically adjustable based on the patient's heart rate, ensuring appropriate exercise intensity. Thus, the patient is capable of exercising waist muscles to promote lumbar blood circulation.

The patient's feet are capable of being fixed to two pedal plates 204 for knee flexion exercises. When the feet drive the pedal plates 204, the limiting blocks 205 at ends of the pedal plates 204 slide along the limiting grooves 202, enabling the pedal plates 204 to drive the sliding plates 207 and a bottom friction plate 209 to move. The compression springs 208 press the sliding plates 207 and the friction plate 209 downward against a rubber plate 210, thereby creating resistance that the patient experiences during knee flexion. This resistance contributes to strengthening thigh and calf muscles of the patient while promoting leg blood circulation. The patient is capable of improving cardiac function and assisting cardiac rehabilitation through appropriate waist and leg exercises. Combined waist-leg training enables patients confined to bed for extended periods to perform cardiac rehabilitation exercises, rather than exercising through walking or sprinting, thereby preventing excessive burden on the heart of the patient.

### EMBODIMENT 2

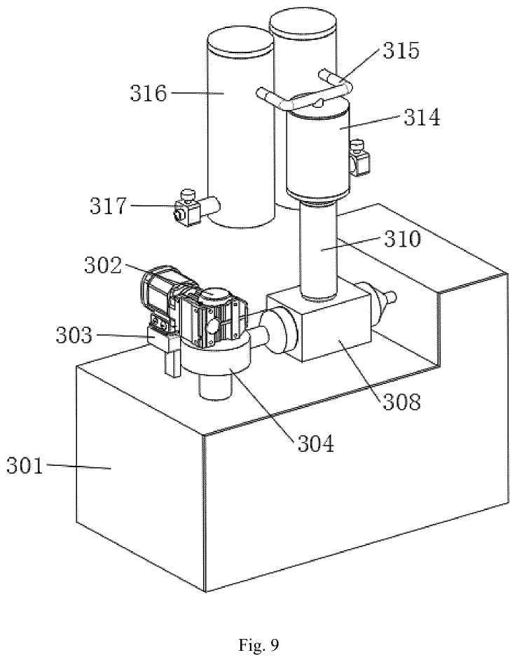

As shown in FIGS. 9-12, in this embodiment, the adjustment mechanism 300 comprises: a straight tube 306, fixedly connected to a bottom of the circular shell 304; an auger 307, fixedly connected to a center of the impeller 305 and rotatably sleeved inside the straight tube 306; and a throttle valve 309, fixedly connected to an end portion of the four-way shell 308. A sealing cylinder 310, fixedly connected to a top of the four-way shell 308 and in communication with an inner portion of the four-way shell 308; a hydraulic rod 311, slidably sleeved inside the sealing cylinder 310; an extrusion spring 312, fixedly sleeved over an outer portion of the hydraulic rod 311; a first piston disk 313, fixedly connected to a top end of the hydraulic rod 311; a pneumatic cylinder 314, slidably sleeved over the first piston disk 313; and a branch tube 315, fixedly connected to a center position of a top end of the pneumatic cylinder 314. Two adjustment cylinders 316, symmetrically and fixedly connected to an end portion of the branch tube 315; a one-way valve 317, fixedly provided on an outer wall of each of the adjustment cylinders 316; two second piston disks 318, each slidably sleeved inside each of the adjustment cylinders 316, and a circular ring for limiting a position of one of the second piston disks 318 at a bottom end is fixedly connected to an inner wall of each of the adjustment cylinders 316; three pressure springs 319, fixedly connected between the two second piston disks 318; and an airbag 320, provided at a top end of each of the adjustment cylinders 316 and abutting against a top of one of the second piston disks 318.

During the specific implementation, the heart rate belt 109 is capable of detecting the heart rate of the patient during exercise. Then, the detected heart rate data is transmitted to a microcontroller for signal processing and heart rate calculation. The microcontroller converts the heart rate data into PWM (Pulse Width Modulation) signals and then transmits the PWM signals to a motor driver. The motor driver controls rotational speed of the motor based on the PWM signals, wherein heart rate values are mapped to the PWM signals such that higher heart rates reduce the PWM duty cycles, thereby decreasing the motor rotational speed.

In the device, an output end of the drive motor 302 drives an impeller 305 at a reduced rotational speed, so that less water is pumped from a liquid storage tank 301 into the four-way shell 308. As the ends of the four-way shell 308 sustain flow via a throttle valve 309, hydraulic pressure within the four-way shell 308 decreases. Then, reduced hydraulic pressure on a hydraulic rod 311 allows the hydraulic rod 311 to descend under extrusion force from an extrusion spring 312. Thus, descending motion of a first piston disk 313 extracts air from two airbags 320, therefore the airbags 320 gradually contract. Consequently, positions of a top one of the second piston disks 318 rise. This reduces pressure applied by the pressure springs 319 to a bottom one of the second piston disks 318, thereby reducing resistance encountered by the patient during waist twisting. As the square tube 212 communicates with the four-way shell 308 through a hose 213, when hydraulic pressure in the four-way shell 308 decreases, a height of the rubber plate 210 also decreases. Consequently, abutment force between the friction plate 209 and the rubber plate 210 diminishes, even causing separation between the rubber plate 210 and the friction plate 209. This reduces resistance encountered by the patient during knee flexion exercises. Thus, upon detecting increased heart rate of the patient via the heart rate belt 109, the device will reduce movement resistance correspondingly. Conversely, when the heart rate of the patient gradually returns to a normal state, the adjustment mechanism 300 will progressively increase movement resistance. This configuration is capable of preventing excessive exercise intensity in cardiac patients while facilitating cardiac rehabilitation therapy.

For persons skilled in the art, it is apparent that the present disclosure is not limited to the details of the exemplary embodiments described above. The present disclosure may be embodied in other specific forms without departing from the spirit or essential characteristics of the present disclosure. Therefore, from any perspective, the embodiments should be regarded as illustrative and non-restrictive. The scope of the present disclosure is defined by the appended claims rather than the foregoing description. Thus, all changes falling within the meaning and scope of equivalent elements of the claims are intended to be embraced by the present disclosure. No reference signs in the claims shall be construed as limiting the claims involved.

Furthermore, it should be understood that although the specification is described according to embodiments, not every embodiment includes only one independent technical solution. The narrative manner of the specification is merely for clarity. Persons skilled in the art should treat the specification as a whole. The technical solutions in the various embodiments may also be appropriately combined to form other embodiments comprehensible to persons skilled in the art.

What is claimed is:

1. A cardiac rehabilitation assistive therapy device, comprising:
an exercise assistance mechanism, configured to assist a patient in performing reciprocal waist twisting exercises, wherein the exercise assistance mechanism comprises a turntable;
a knee flexion mechanism, configured to assist the patient in performing leg knee flexion exercises, wherein the knee flexion mechanism is fixedly arranged at a bottom of the turntable; and
an adjustment mechanism, configured to automatically adjust exercise resistance based on the patient's heart rate, wherein the adjustment mechanism comprises a liquid storage tank, a control box is fixedly connected to a top of the liquid storage tank, a microcontroller is fixedly connected inside the control box, a drive motor is fixedly connected to a top of the control box, a motor drive device is fixedly connected to the drive motor, a circular shell is fixedly connected to a bottom of the drive motor, an impeller is fixedly connected to an output end of the drive motor, and a four-way shell is fixedly connected to one side of the circular shell.

2. The cardiac rehabilitation assistive therapy device according to claim 1, wherein the exercise assistance mechanism comprises:
a backrest plate, fixedly connected to a top of the turntable;
a seat cushion, fixedly provided on the turntable;
a rotating column, fixedly connected to a center position of the bottom of the turntable;
a support frame, rotatably sleeved over an outer portion of the rotating column;
two L-shaped plates, symmetrically and fixedly connected to a top of the support frame;
a U-shaped rod, wherein one end of the U-shaped rod is rotatably connected to one of the L-shaped plates;
two grip handles, symmetrically and fixedly connected to a side wall of the U-shaped rod; and
a heart rate belt, fixedly connected to the side wall of the U-shaped rod.

3. The cardiac rehabilitation assistive therapy device according to claim 2, wherein a clamping block is slidably embedded in one of the L-shaped plates, a pull rod is fixedly connected to an end portion of the clamping block, a return spring is sleeved over an outer portion of the pull rod, and an end portion of the return spring is fixedly connected to an inner wall of one of the L-shaped plates.

4. The cardiac rehabilitation assistive therapy device according to claim 2, wherein the exercise assistance mechanism comprises:
two arc-shaped rods, symmetrically and fixedly connected to an outer wall of the rotating column;
two piston blocks, each fixedly connected to an end portion of one of the arc-shaped rods;
two arc-shaped sleeves, each slidably sleeved over an outer portion of one of the arc-shaped rods;
two connecting tubes, each fixedly connected at one end to an end portion of one of the arc-shaped sleeves, wherein each of the arc-shaped sleeves is in communication with an inner portion of each of the connecting tubes; and
two positioning arms, each fixedly sleeved over an outer portion of one of the arc-shaped sleeves.

5. The cardiac rehabilitation assistive therapy device according to claim 2, wherein the knee flexion mechanism comprises:
a support plate, configured to support a leg of the patient;
two limiting grooves, symmetrically formed in the support plate;
a positioning base, fixedly connected to the bottom of the turntable, wherein an end portion of the support plate is fixedly connected to the positioning base;
two pedal plates, slidably embedded in and connected to each of the limiting grooves;
two limiting blocks, each fixedly connected to a side wall of each of the pedal plates, wherein each of the limiting blocks is slidably embedded in and connected to each of the limiting grooves;
two ankle straps, wherein an end portion of each of the ankle straps is fixedly connected to the side wall of each of the pedal plates;
two sliding plates, each slidably sleeved over a bottom end of each of the pedal plates; and
two compression springs, each fixedly connected to a top of each of the sliding plates.

6. The cardiac rehabilitation assistive therapy device according to claim 5, wherein the knee flexion mechanism comprises:
a friction plate, fixedly connected between bottom ends of the two sliding plates;
a rubber plate, slidably abutting against a bottom of the friction plate; and
a telescopic plate, fixedly connected to a center position of a bottom of the rubber plate.

7. The cardiac rehabilitation assistive therapy device according to claim 6, wherein the knee flexion mechanism comprises:
a square tube, slidably sleeved over the telescopic plate;
a hose, wherein one end of the hose is fixedly connected to a bottom of the square tube, and the square tube is in communication with an inner portion of the hose; and
two limiting rods, symmetrically and fixedly connected to a bottom of the support plate, wherein the rubber plate is slidably sleeved over the limiting rods.

8. The cardiac rehabilitation assistive therapy device according to claim 7, wherein the adjustment mechanism comprises:
a straight tube, fixedly connected to a bottom of the circular shell;
an auger, fixedly connected to a center of the impeller and rotatably sleeved inside the straight tube; and
a throttle valve, fixedly connected to an end portion of the four-way shell.

9. The cardiac rehabilitation assistive therapy device according to claim 7, wherein the adjustment mechanism comprises:
a sealing cylinder, fixedly connected to a top of the four-way shell and in communication with an inner portion of the four-way shell;
a hydraulic rod, slidably sleeved inside the sealing cylinder;
an extrusion spring, fixedly sleeved over an outer portion of the hydraulic rod;
a first piston disk, fixedly connected to a top end of the hydraulic rod;
a pneumatic cylinder, slidably sleeved over the first piston disk; and
a branch tube, fixedly connected to a center position of a top end of the pneumatic cylinder.

10. The cardiac rehabilitation assistive therapy device according to claim 9, wherein the adjustment mechanism comprises:
two adjustment cylinders, symmetrically and fixedly connected to an end portion of the branch tube;
a one-way valve, fixedly provided on an outer wall of each of the adjustment cylinders;
two second piston disks, each slidably sleeved inside each of the adjustment cylinders, and a circular ring for limiting a position of one of the second piston disks at a bottom end is fixedly connected to an inner wall of each of the adjustment cylinders;
three pressure springs, fixedly connected between the two second piston disks; and
an airbag, provided at a top end of each of the adjustment cylinders and abutting against a top of one of the second piston disks.
